(19) United States
(12) Patent Application Publication
(10) Pub. No.: US 2015/0227875 A1
(43) Pub. Date: Aug. 13, 2015

(54) Systems and Methods to Determine Competitiveness of a Long Term Service Agreement

(71) Applicant: General Electric Company, Schenectady, NY (US)

(72) Inventors: Rahul J. Chillar, Atlanta, GA (US); Ryan Hooley, Atlanta, GA (US); Phani Raghavender Gurijala, Atlanta, GA (US); Anthony San Nicolas, Atlanta, GA (US); David Brucker, Atlanta, GA (US)

(73) Assignee: General Electric Company, Schenectady, NY (US)

(21) Appl. No.: 14/175,323

(22) Filed: Feb. 7, 2014

(51) Int. Cl. G06Q 10/06; G06Q 50/06

(52) U.S. Cl. CPC G06Q 10/06315; G06Q 50/06

(57) ABSTRACT

Embodiments of the disclosure relate to analyzing costs, and more particularly, to analyzing costs associated with a power plant asset. In one embodiment, a system can include a first sensor and a first computer communicatively coupled to the first sensor. The first computer can be configured to automatically obtain via the first sensor, a first set of performance parameters of the first power plant asset over a period of time. The first computer can be further configured to compute from the first set of performance parameters, a first cost factor that is defined, at least in part, on the basis of an amount of electric power generated by the first power plant asset over the period of time.

### FIELD OF THE DISCLOSURE

This disclosure relates to determining competitiveness of a service agreement, and more particularly, to determining competitiveness of a service agreement associated with a power plant asset.

### BACKGROUND OF THE DISCLOSURE

Analyzing costs associated with a product or a service can be carried out using a variety of data parameters and a variety of calculations. However, in many cases, a cost analysis carried out by a first entity that is associated with providing the product or service from a particular facility may turn out to be incompatible and/or different with respect to a cost analysis carried out by a different entity that is associated with providing the same product or the same service, say from a different facility. The incompatibility and/or difference in the two cost analyses may be attributable to the use of differing types of data parameters and/or a different set of calculations for arriving at the results.

### BRIEF DESCRIPTION OF THE DISCLOSURE

Embodiments of the disclosure can address some or all of the needs described above. Embodiments of the disclosure are directed generally to systems and methods for analyzing costs associated with one or more power plant asset service agreements.

According to one example embodiment of the disclosure, a system can include a first sensor and a first computer communicatively coupled to the first sensor. The first computer can be configured to automatically obtain via the first sensor, a first set of performance parameters of the first power plant asset over a period of time. The first computer can be further configured to compute from the first set of performance parameters, a first cost factor that is defined, at least in part, on the basis of an amount of electric power generated by the first power plant asset over the period of time.

According to another example embodiment of the disclosure, a method can include using at least a first sensor communicatively coupled to at least a first computer to monitor a first power plant asset, the monitoring directed, at least in part, at automatically obtaining performance parameters of the first power plant asset over a period of time. The method can further include using the performance parameters obtained from the first power plant to automatically compute a first cost factor that is proportional, at least in part, to an amount of electric power generated by the first power plant asset over the period of time.

According to yet another example embodiment of the disclosure, a computer-readable storage medium can be provided. The computer-readable storage medium has stored instructions executable by a computer for performing operations that can include automatically obtaining performance parameters of a first power plant asset over a period of time; and computing from the performance parameters obtained from the first power plant, a first cost factor that is defined, at least in part, on the basis of an amount of electric power generated by the first power plant asset over the period of time.

Other embodiments, features, and aspects of the disclosure will become apparent from the following description taken in conjunction with the following drawings.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a functional block diagram representing an example system for determining competitiveness of a service agreement associated with a power plant asset according to an example embodiment of the disclosure.

FIG. 2 illustrates a functional block diagram representing another example system for determining competitiveness of a service agreement associated with a power plant asset according to an example embodiment of the disclosure.

FIG. 3 illustrates a functional block diagram representing a process for determining competitiveness of a service agreement associated with a power plant asset according to an example embodiment of the disclosure.

FIG. 4 illustrates an example computer incorporating a processor for determining competitiveness of a service agreement associated with a power plant asset according to an example embodiment of the disclosure.

FIG. 5 illustrates a flowchart of a method for determining competitiveness of a service agreement associated with a power plant asset according to an example embodiment of the disclosure.

### DETAILED DESCRIPTION OF THE DISCLOSURE

The disclosure now will be described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will satisfy applicable legal requirements. Like numbers refer to like elements throughout.

In accordance with this disclosure, a power plant asset, for example, a power generating turbine that is owned or leased by a first entity can be used for generating electric power. The first entity can be, for example, a customer. The first entity may sign a service agreement with a second entity such as for example, a sales agent, a service provider, or a manufacturer of the power plant asset to provide a certain level of performance of the power plant asset over a period of time. The service agreement can specify the period of time, for example, a certain number of years, during which the second entity provides to the first entity, various services associated with the power plant asset such as for example, operations-related services, outage-related services, parts replacement services, and/or repair services.

Typically, the first entity and the second entity enter into a financial arrangement for execution of the service agreement. In one example embodiment, the financial arrangement can specify a certain amount of money that is to be paid by the first entity to the second entity based on the number of hours that the power plant asset generates power. Various metrics may be employed to calculate the number of hours that the power plant asset generates power. However, some of these metrics may fail to take into consideration the efficiency with which the power plant asset generates a certain amount of power.

For example, in one case, a first power plant asset may provide a desired power output with very few failures during the period of time specified in a service contract. In contrast, a second power plant asset may suffer numerous stoppages due to various reasons during the same period of time specified in another service contract. Understandably, the poor operational performance of the second power plant asset may translate to a cost penalty, both in terms of power output and in terms of financial losses that may be suffered by both the first entity and the second entity.

Consequently, a cost factor in accordance with the disclosure can be used to not only perform a cost analysis of any individual power plant asset but can be used as a standard measure for performing a comparative cost analysis between two or more power plant assets as well.

The first entity that owns or leases a power plant asset can be referred to hereinafter as a “customer” and the second entity that signs the service agreement for providing various services with respect to the power plant asset can be referred to hereinafter as a “manufacturer.” It will be understood that this nomenclature is used solely as a matter of convenience for description purposes and it will be further understood that the systems and methods described in this disclosure can be applied to various objects other than a power plant asset (that may or may not be covered under a service contract) and to entities other than a customer or a manufacturer.

Typically, the cost factor is used by the manufacturer to obtain a holistic view of costs involved in fulfilling service agreements with one or more customers and can be broadly defined as a monetary currency value per megawatt hour.

In one example embodiment, the cost factor is defined in terms of dollars per megawatt hour ($/MwH). With reference to the power plant asset, the $/MwH is indicative of the cost of generating a certain amount of power in megawatts (Mw) per hour by the power plant asset. For optimum benefit, it is desirable that the cost ($ amount) be minimized, the generated power (Mw) be maximized, and the period of time (H) over which the power is generated be maximized as well.

The cost ($ amount) can be minimized in several ways, such as, for example, by reducing costs associated with replacement parts, repairs, outages, and maintenance services. The generated power (Mw) can be maximized by several ways, such as, for example, by increasing power output and by reducing the rate of heat generation. The period of time (H) over which the power is generated may be maximized by several ways, such as, for example, by improving the reliability of the power plant asset and by improving the availability of the power plant asset.

In various alternative embodiments, rather than defining the cost factor in terms of a currency value per megawatt hours, the cost factor can be defined with a finer modularity. For example, the cost factor can be defined as a monetary currency value per kilowatt hour, per watt hour, or any other suitable metric for defining electric power generated by the power plant asset over a period of time and/or at a certain rate.

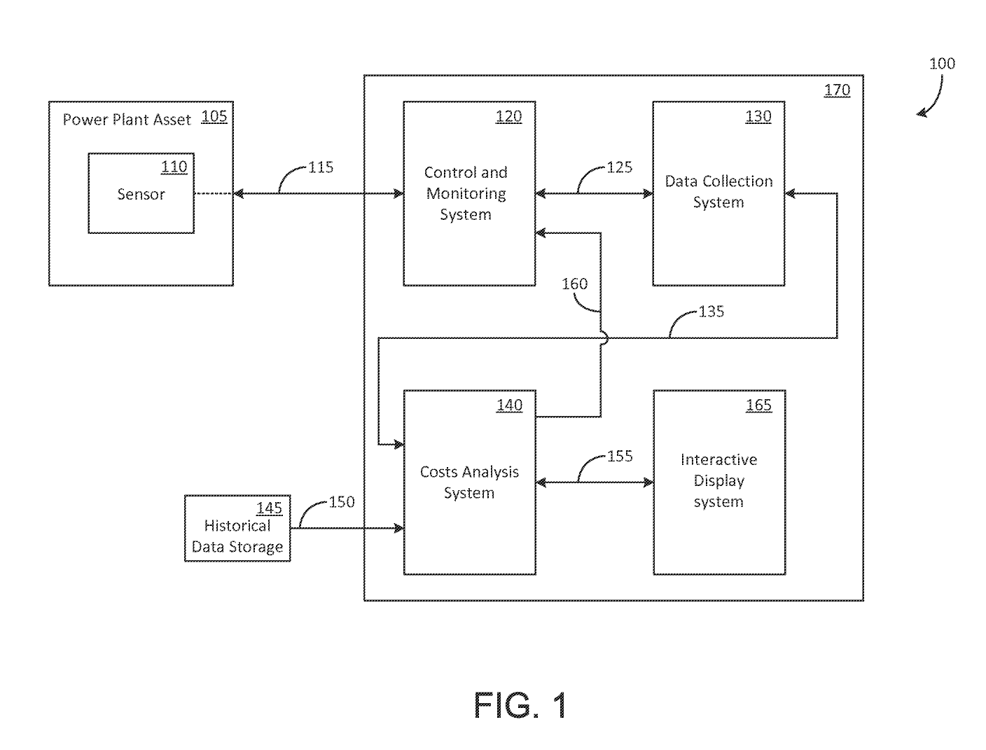

Attention is now drawn to FIG. 1, which illustrates a functional block diagram representing an example system 100 for determining competitiveness of a service agreement associated with a power plant asset according to an example embodiment of the disclosure. System 100 can include a power plant asset 105 that is owned or leased by a customer (not shown) and is subject to a service agreement provided by, for example, a manufacturer (not shown) of the power plant asset 105. The customer may desire that the power plant asset 105 provide an optimal level of performance at least over the period of time during which the power plant asset 105 is covered by the service agreement, while the manufacturer may desire to minimize costs associated with honoring the service agreement.

As a part of minimizing the costs, the manufacturer can use the cost factor in accordance with the disclosure to perform a cost analysis of the power plant asset 105. The results of the cost analyses performed on the power plant asset 105 can be used for comparing against cost analysis results derived from another power plant asset that may be covered by another similar or dissimilar service agreement.

Towards this end, the power plant asset 105 can be communicatively coupled to a control and monitoring system 120. More particularly, a sensor 110 that is incorporated into the power plant asset 105 can be communicatively coupled to the control and monitoring system 120.

It should be understood that various components of the system 100 can be implemented using one or more computers. In the example embodiment shown in FIG. 1, the various components are implemented using a single computer 170. However, in other example embodiments, multiple computers can be used. For example, the control and monitoring system 120 can be implemented using a first computer, while the data collection system 130 can be implemented using another computer. In some implementations, multiple systems can be implemented using a single computer.

It should also be understood that various components of the system 100 can be communicatively coupled to each other via a variety of networks and a variety of communication links. A few examples of networks include the Internet, a local area network, and a wide area network. A few examples of communication links include a wired communication link, a fiber optic communication link, and/or a wireless communication link. Furthermore, various components of the system 100 can be co-located at one location or can be located in geographically diverse locations.

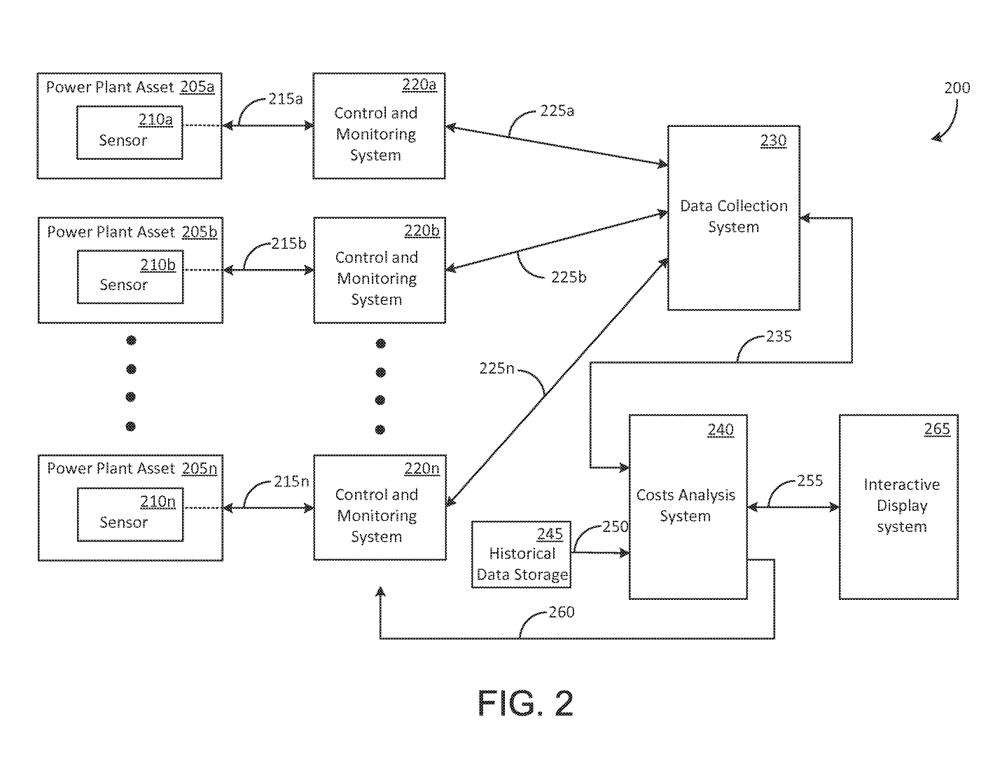

In one example implementation, power plant asset 105 can be communicatively coupled to the control and monitoring system 120 via a communication link 115 that can be a part of a network. Communication link 115 can be a wired communication link, a fiber optic communication link, and/or a wireless communication link. Furthermore, communication link 115 as well as several other communication links shown in FIG. 1 (as well as FIG. 2) can be bi-directional in nature in order to communicate various types of signals in two opposing directions if so desired.

Sensor 110 that is incorporated into the power plant asset 105 can be implemented in a variety of ways for monitoring a variety of parameters. For example, in one example implementation, the sensor 110 can be a status sensor for monitoring an operational status of a part of the power plant asset 105. The operational status of the part can be related to, for example, monitoring performance parameters (rpm, electrical power output, heat etc.) and/or for generating various alarms related to a failure or a malfunction.

One or more signals generated in the power plant asset 105 by the sensor 110, or by other components of the power plant asset 105, are communicated to the control and monitoring system 120. The one or more signals can be communicated by the power plant asset 105 to the control and monitoring system 120 upon receiving a control signal or a command signal from the control and monitoring system 120 via the communication link 115 for the purpose of facilitating performance of cost analysis in accordance with the disclosure. More particularly, the one or more control signals and/or one or more command signals can be selected to collect information pertinent to cost analysis, such as for example, temperature data, reliability data, and/or availability data, from the power plant asset 105.

The information collected by the control and monitoring system 120 is forwarded to the data collection system 130 via a communication link 125. In some implementations, the control and monitoring system 120 forwards the information to the data collection system 130 after processing the information. The processing can include filtering, formatting, and/or modifying the information so as to make the information more suitable for forwarding to the data collection system 130.

The data collection system 130 can operate as a temporary storage entity for storing data provided by the control and monitoring system 120. The data collection system 130 can also process the stored data. The processing can include filtering, formatting, and/or modifying the information so as to make the information more suitable for storing and/or for performing cost analysis.

The data collection system 130 can forward the data to the cost analysis system 140 via a communication link 135. The cost analysis system 140 carries out a cost analysis in one of various ways in accordance with the disclosure. In one example process, the cost analysis system 140 can perform cost analysis by using data stored in the historical data storage 145 for analyzing past costs and current costs as well as for predicting future cost trends. The results of the cost analysis can be used in two different ways. First, the cost analysis system 140 can generate communications, such as alarms for example, that are forwarded via a communication link 160 to the control and monitoring system 120. The control and monitoring system 120 can use the communications for executing remedial operations upon the power plant asset 105. Second, the cost analysis system 140 can generate signals that are propagated via a communication link 155 to the interactive display system 165 for displaying the results of the cost analysis.

Interactive display system 165 can be used not only for displaying cost analysis results but can also be used to interact with the cost analysis system 140 for various reasons. For example, a first interaction initiated via the interactive display system 165 can be a query for obtaining a cost analysis results over a certain period of time in the past, a second interaction can be a query requesting cost analysis predictions over a future period of time, and a third interaction can be input provided by a human being for configuring the cost analysis system 140 to execute various cost analysis algorithms. Interactive display system 165 can be further used for providing commands, controls, and instructions via the cost analysis system 140 and communication link 160 for effecting changes on the power plant asset 105.

Attention is now drawn to FIG. 2, which illustrates a functional block diagram representing another example system 200 for determining competitiveness of a service agreement associated with a power plant asset according to an example embodiment of the disclosure. FIG. 2 contains several functional blocks that are similar to those shown in FIG. 1 and the functionalities of the various blocks shown in FIG. 2 can therefore be understood from the description provided above with reference to FIG. 1. However, in contrast to system 100, which is used for performing cost analyses on a single power plant asset (power plant asset 105) in accordance with the disclosure, system 200 is used for performing cost analyses in accordance with the disclosure on multiple power plant assets that are generally designated by numeric designators 205A through 205N (where “N”>1). System 200 also includes multiple control and monitoring systems that are generally designated by numeric designators 220A through 220N (where “n”>1).

Data collection system 230 is communicatively coupled to control and monitoring systems 220A-220N via communication links 225A-225N. The data collection system 230 can operate as a temporary storage entity for storing data provided by control and monitoring systems 220A-220N. The data collection system 230 can also process the stored data. The processing can include filtering, formatting, and/or modifying the information so as to make the information more suitable for storing and/or for performing cost analysis.

The data collection system 230 forwards the data to the cost analysis system 240 via a communication link 235. The cost analysis system 240 can be configured to not only perform the operations described above with respect to data collection system 130, but is further configured to execute comparative cost analyses. For example, cost analysis system 240 can be configured to carry out a comparative cost analysis between two or more of power plant assets 205A-205N.

The cost analysis system 240 can perform cost analysis by using data stored in the historical data storage 245 for analyzing past costs as well as for predicting future cost trends. The results of the cost analysis can be used in two different ways. First, the cost analysis system 240 can generate communications, such as alarms for example, that are forwarded via communication link 260 to a respective control and monitoring system 220A-220N. The respective control and monitoring system 220A-220N can use these communications for executing remedial operations upon the respective power plant asset 205A-205N. Second, the cost analysis system 240 can generate signals that are propagated to the interactive display system 265 via a communications link 255 for displaying the results of the cost analysis.

Interactive display system 265 provides functionalities that can be similar to those described above with respect to interactive display system 265 and can include additional functionalities associated with comparative cost analyses results.

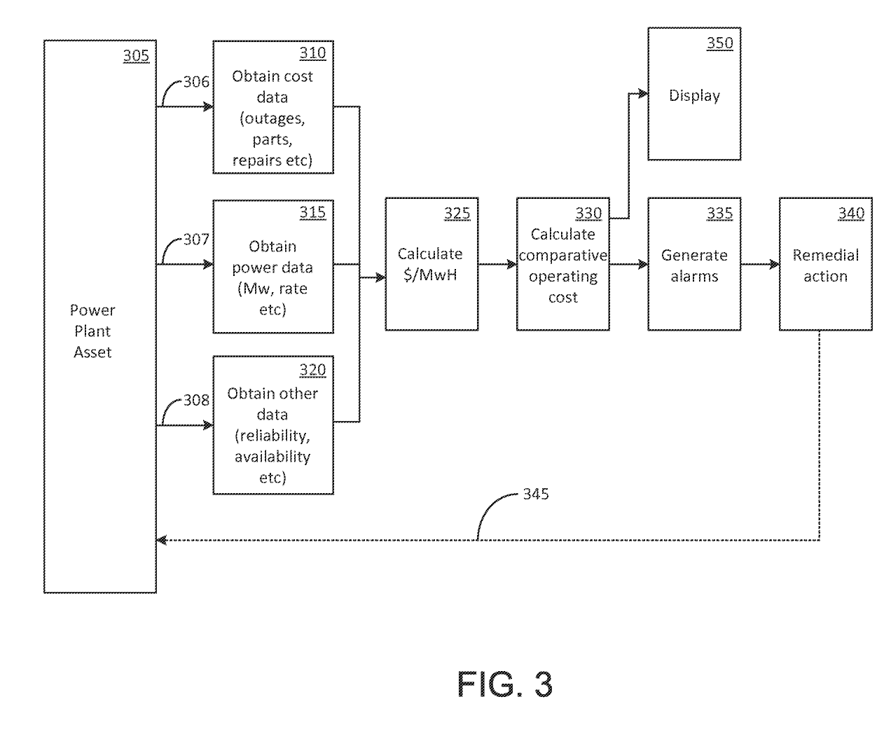

FIG. 3 illustrates a functional block diagram representing a process for determining competitiveness of a service agreement associated with a power plant asset according to an example embodiment of the disclosure. Various parameters of a power plant asset 305 are collected for carrying out a cost analysis in accordance with the disclosure. Specifically, block 310 indicates collection of cost related data such as for example outages cost, parts costs, and repairs cost that can be collected in a variety of ways. For example, in one example implementation, block 310 can be implemented as a computer that is communicatively coupled to power plant asset 305 via communication link 306 so as to collect cost related data in an automated format. Cost related data may also be provided to the computer in a non-automated manner, such as via manual data entry by a computer operator.

Block 315 indicates collection of power related data such as for example, the amount of power in watts generated by the power plant asset 305 over a certain period of time, the efficiency with which a certain amount of power was generated over a certain period of time, and thermal data over a certain period of time. Block 310 can be implemented as a computer that is communicatively coupled to power plant asset 305 via communication link 307 so as to collect power related data in an automated format.

Block 320 indicates collection of other parameters such as for example, reliability parameters, breakdown data, and availability data. Block 320 can be implemented as a computer that is communicatively coupled to power plant asset 305 via communication link 308 so as to collect various types of data in an automated format. Data may also be provided to the computer in a non-automated manner, such as via manual data entry by a computer operator.

Block 310, block 315, and block 320 provide information to block 325 wherein a cost factor, such as $/MwH, is calculated in accordance with the disclosure. Block 330 uses the cost factor derived in block 325 to execute a comparative operative cost analysis by using the cost factor derived from the power plant asset 305 and one or more cost factors derived from one or more power plant assets other than the power plant asset 305.

The results of the comparative operative cost analysis can be used to obtain a wide variety of information, such as for example, which one of the various power plant assets is providing the best cost factor, which metrics may be improved in order to improve a cost factor of a power plant asset that is not providing optimum performance, historical cost data associated with one or more power plant asset, trends in cost associated with one or more power plant asset, costs associated with one or more parts, costs associated with one or more services, costs associated with one or more repairs, and/or how to optimize the nature and/or the period of time specified in one or more service agreements associated with one or more power plant asset.

The process illustrated in FIG. 3 permits cost analysis in non-real time as well as real-time mode. When in real-time mode (or near real time mode) various parameters associated with operating the power plant asset 305 can be iteratively tweaked to obtain a different cost objective.

The results of the comparative operative cost analysis generated in block 330 can be displayed (as indicated in block 350). The display can be carried out using the interactive display system 165 described above. In one example implementation, display 350 can use an interactive dashboard display for viewing the results of the comparative operative cost analysis in a real time mode.

The results of the comparative operative cost analysis derived in block 330 can be also acted upon in block 335, where various types of alarms can be generated based on the results. The various types of alarms can be categorized for example, as red, green, and yellow alarms based on certain threshold parameters associated with the cost related results.

In block 340, remedial action can be taken on the basis of the alarms generated in block 335. For example, the operation of the power plant asset 305 can be directly modified to effect changes upon one or more of the cost related parameters that are provided to one or more of block 310, block 315, and block 320. When block 340 is implemented in a computer, the remedial action can be a control signal or command that is propagated to the power plant asset 305 via communication link 345. However, in certain embodiments, the remedial action can be used to carry out indirect modifications to effect changes upon one or more of the cost related parameters shown in one or more of block 310, block 315, and block 320. For example, the cost of repairs or the cost of parts can be modified so as to effect changes in the cost results.

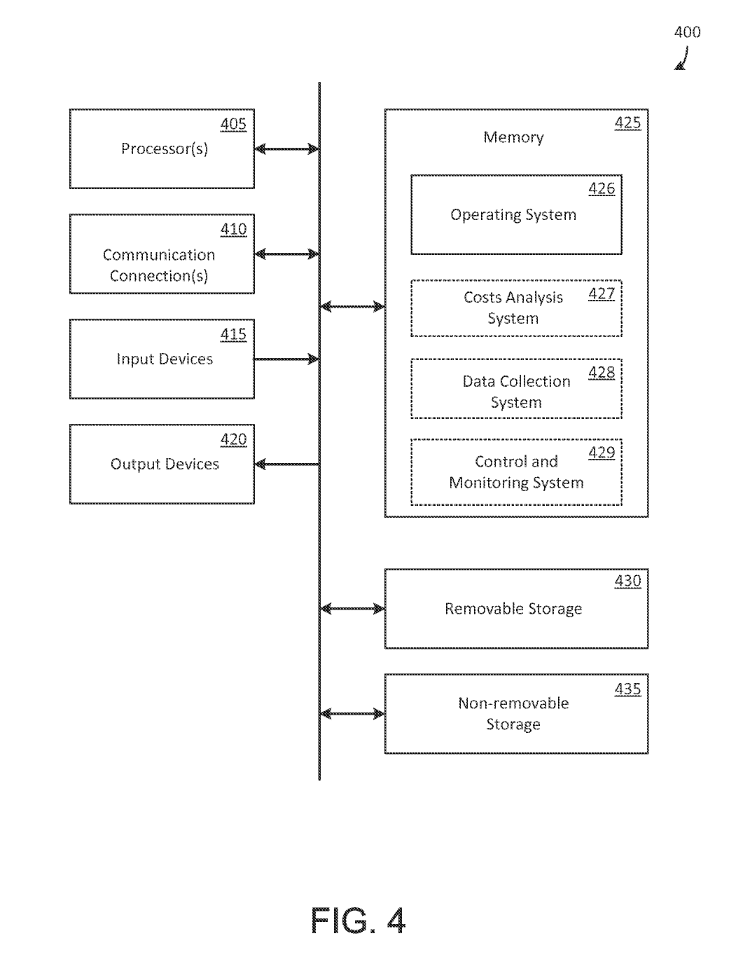

Attention is now drawn to FIG. 4 that shows a block diagram of a computer 400 for implementing the systems and methods for determining competitiveness of a service agreement associated with a power plant asset in accordance with example embodiments of the disclosure. The computer 400 can include a processor 405 capable of communicating with a memory 425. The computer 400 can be implemented as appropriate in hardware, software, firmware, or combinations thereof. Software or firmware implementations of the computer 400 can include computer-executable or machine-executable instructions written in any suitable programming language to perform the various functions described. In one embodiment, instructions associated with a function block language can be stored in the memory 425 and executed by the processor 405.

The memory 425 can be used to store program instructions that are loadable and executable by the processor 405 as well as to store data generated during the execution of these programs. Depending on the configuration and type of computer 400, memory 425 can be volatile (such as random access memory (RAM)) and/or non-volatile (such as read-only memory (ROM), flash memory, etc.). In some embodiments, the memory devices can also include additional removable storage 430 and/or non-removable storage 435 including, but not limited to, magnetic storage, optical disks, and/or tape storage. The disk drives and their associated computer-readable media can provide non-volatile storage of computer-readable instructions, data structures, program modules, and other data for the devices. In some implementations, memory 425 can include multiple different types of memory, such as static random access memory (SRAM), dynamic random access memory (DRAM), or ROM.

The memory 425, removable storage 430, and non-removable storage 435 are all examples of computer-readable storage media. For example, computer-readable storage media can include volatile and non-volatile, removable and non-removable media implemented in any method or technology for storage of information such as computer-readable instructions, data structures, program modules or other data. Additional types of computer storage media that can be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tapes, magnetic disk storage or other magnetic storage devices, or any other medium which can be used to store the desired information and which can be accessed by the devices. Combinations of any of the above should also be included within the scope of computer-readable media.

Computer 400 can also include one or more communication connections 410 that can allow a control device (not shown) to communicate with devices or equipment capable of communicating with computer 400. The connections can be established via various data communication channels or ports, such as USB or COM ports to receive cables connecting the control device to various other devices on a network. In one embodiment, the control device can include Ethernet drivers that enable the control device to communicate with other devices on the network. According to various embodiments, communication connections 410 can be established via a wired and/or wireless connection on the network.

Computer 400 can also include one or more input devices 415, such as a keyboard, mouse, pen, voice input device, and touch input device. It can further include one or more output devices 420 such as a display, printer, and speakers.

In other embodiments, however, computer-readable communication media can include computer-readable instructions, program modules, or other data transmitted within a data signal, such as a carrier wave, or other transmission. As used herein, however, computer-readable storage media do not include computer-readable communication media.

Turning to the contents of the memory 425, the memory 425 can include, but is not limited to, an operating system (OS) 426 and one or more application programs or services for implementing the features and aspects disclosed herein. Such applications or services can include one or more of the costs analysis system 427, the data collection system 428, and the control and monitoring system 429. When executed by processor 405, the one or more of the costs analysis system 427, the data collection system 428, and the control and monitoring system 429 implement the various functionalities and features described in this disclosure.

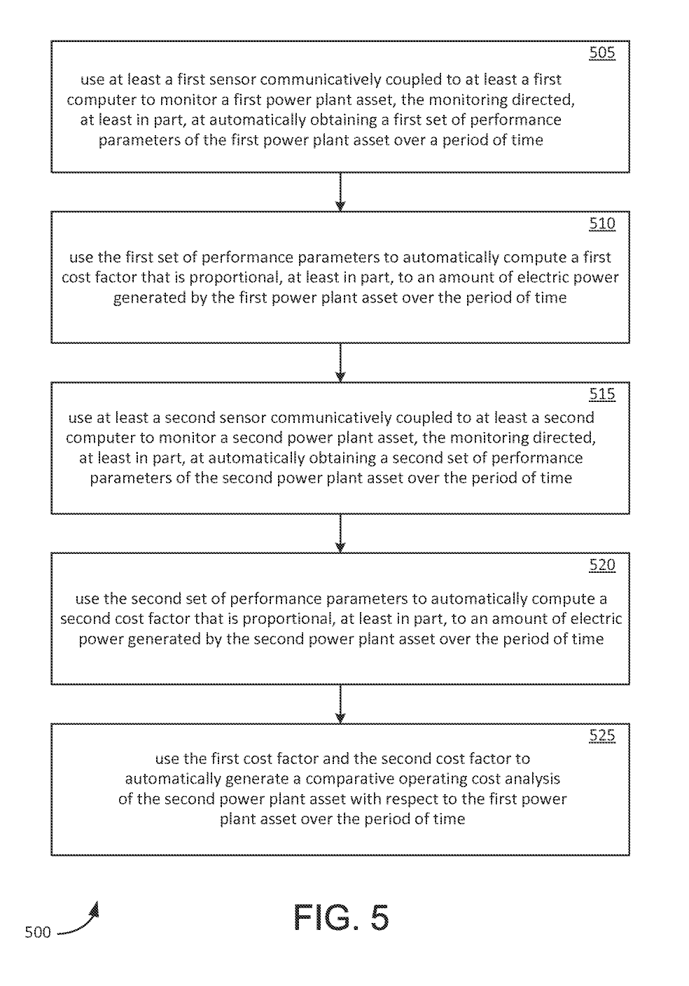

FIG. 5 illustrates an example flowchart 500 of a method for determining competitiveness of a service agreement associated with a power plant asset according to one example embodiment of the disclosure. In block 505, at least a first sensor that is communicatively coupled to at least a first computer, is used to monitor a first power plant asset. The monitoring is directed, at least in part, at automatically obtaining a first set of performance parameters of the first power plant asset over a period of time.

In block 510, the first set of performance parameters is used to automatically compute a first cost factor that is proportional, at least in part, to an amount of electric power generated by the first power plant asset over the period of time.

In block 515, at least a second sensor communicatively that is coupled to at least a second computer is used to monitor a second power plant asset. The monitoring is directed, at least in part, at automatically obtaining a second set of performance parameters of the second power plant asset over the period of time.

In block 520, the second set of performance parameters is used to automatically compute a second cost factor that is proportional, at least in part, to an amount of electric power generated by the second power plant asset over the period of time

In block 525, the first cost factor and the second cost factor are used to automatically generate a comparative operating cost analysis of the second power plant asset with respect to the first power plant asset over the period of time.

References are made herein to block diagrams of systems, methods, apparatuses, and computer program products according to example embodiments of the disclosure. It will be understood that at least some of the blocks of the block diagrams, and combinations of blocks in the block diagrams, respectively, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational elements to be performed on the computer or other programmable apparatus to produce a computer implemented process such that the instructions that execute on the computer or other programmable apparatus provide elements for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based, or programmable consumer electronics, mini-computers, mainframe computers, etc.

Application programs that are components of the systems and methods described herein may include routines, programs, components, data structures, etc. that implement certain abstract data types and perform certain tasks or actions. In a distributed computing environment, the application program (in whole or in part) may be located in local memory, or in other storage. In addition, or in the alternative, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated the disclosure may be embodied in many forms and should not be limited to the example embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A system comprising:
a first sensor; and
a first computer communicatively coupled to the first sensor, the first computer configured to:
automatically obtain via the first sensor, a first set of performance parameters of a first power plant asset over a period of time; and
compute from the first set of performance parameters, a first cost factor that is defined, at least in part, on the basis of an amount of electric power generated by the first power plant asset over the period of time.

2. The system of claim 1, further comprising:
a second sensor; and
a second computer communicatively coupled to the second sensor, the second computer configured to:
automatically obtain via the second sensor, a second set of performance parameters of a second power plant asset over a period of time;
compute from the second set of performance parameters, a second cost factor that is defined, at least in part, on the basis of an amount of electric power generated by the second power plant asset over the period of time; and
use the first cost factor and the second cost factor to generate a comparative operating cost analysis of the second power plant asset with respect to the first power plant asset over the period of time.

3. The system of claim 2, wherein each of the first cost factor and the second cost factor is defined by a monetary currency value per megawatt hour.

4. The system of claim 1, wherein the first power plant asset is a power generating turbine and wherein the first cost factor is further defined on the basis of operating costs of the power generating turbine over the period of time.

5. The system of claim 4, wherein the operating costs comprises at least one of: a cost for providing one or more repair services, a replacement part cost, a cost for providing a maintenance service, a cost for providing an operational service, an outage cost, or a penalty cost.

6. The system of claim 1, further comprising:
a second computer configured to provide an interactive user interface, the interactive user interface configured to display at least one alarm when the first cost factor exceeds a predefined threshold.

7. The system of claim 6, wherein the second computer is one of communicatively coupled to the first computer or the same as the first computer, and is further configured to modify at least one operating characteristic of the first power plant asset in response to the alarm.

8. A method comprising:
using at least a first sensor communicatively coupled to at least a first computer to monitor a first power plant asset, the monitoring directed, at least in part, at automatically obtaining performance parameters of the first power plant asset over a period of time; and
using the performance parameters obtained from the first power plant to automatically compute a first cost factor that is proportional, at least in part, to an amount of electric power generated by the first power plant asset over the period of time.

9. The method of claim 8, further comprising:
using at least a second sensor communicatively coupled to at least a second computer to monitor a second power plant asset, the monitoring directed, at least in part, at automatically obtaining performance parameters of the second power plant asset over the period of time;
using the performance parameters obtained from the second power plant to automatically compute a second cost factor that is proportional, at least in part, to an amount of electric power generated by the second power plant asset over the period of time; and
using the first cost factor and the second cost factor to automatically generate a comparative operating cost analysis of the second power plant asset with respect to the first power plant asset over the period of time.

10. The method of claim 9, wherein the period of time is a predetermined contract period during which each of the first power plant asset and the second power plant asset is provided contractual services comprising maintenance, repairs, and parts replacement.

11. The method of claim 10, wherein each of the first power plant asset and the second power plant asset is a power generating turbine.

12. The method of claim 10, wherein each of the first cost factor and the second cost factor is defined by a monetary currency value per megawatt hour.

13. The method of claim 8, further comprising:
generating at least one alarm when the first cost factor exceeds a predefined threshold.

14. The method of claim 13, wherein the at least one alarm comprises a first alarm that is generated when the first cost factor exceeds a first predefined threshold, and a second alarm that is generated when the first cost factor exceeds a second predefined threshold.

15. The method of claim 13, further comprising:
modifying at least one operating characteristic of the first power plant asset in response to the alarm.

16. The method of claim 15, wherein modifying the at least one operating characteristic of the first power plant asset comprises reducing heat generation in the first power plant asset.

17. The method of claim 15, wherein modifying the at least one operating characteristic of the first power plant asset comprises modifying the amount of electric power generated by the first power plant asset.

18. A computer-readable storage medium having stored thereon, instructions executable by a computer for performing operations comprising:
automatically obtaining performance parameters of a first power plant asset over a period of time; and
computing from the performance parameters obtained from the first power plant, a first cost factor that is defined, at least in part, on the basis of an amount of electric power generated by the first power plant asset over the period of time.

19. The computer-readable storage medium of claim 18, further including instructions for:
automatically obtaining performance parameters of a second power plant asset over the period of time;
computing from the performance parameters obtained from the second power plant, a second cost factor that is defined, at least in part, on the basis of an amount of electric power generated by the second power plant asset over the period of time; and
using the first cost factor and the second cost factor to generate a comparative operating cost analysis of the second power plant asset with respect to the first power plant asset over the period of time.

20. The computer-readable storage medium of claim 18, wherein the first power plant asset is a power generating turbine, and wherein the first cost factor is defined by a monetary currency value per megawatt hour that is indicative of costs associated with operating the power generating turbine over the period of time.
